(19) United States
(12) Patent Application Publication
(10) Pub. No.: US 2004/0050951 A1
(43) Pub. Date: Mar. 18, 2004

(54) Device for diffusing a fluid into atmosphere with secured removable reservoir

(76) Inventor: Jean-Jacques Almero, Toulouse (FR)

Correspondence Address: YOUNG & THOMPSON, 745 SOUTH 23RD STREET 2ND FLOOR, ARLINGTON, VA, 22202

(21) Appl. No.: 10/433,152

(22) PCT Filed: Dec. 11, 2001
(86) PCT No.: PCT/FR01/03935

(30) Foreign Application Priority Data
Dec. 13, 2000 (FR) 00/16232

(51) Int. Cl. A01G 27/00

(52) U.S. Cl. 239/69

(57) ABSTRACT

A device for diffusing at least a fluid into the atmosphere, comprises at least a fluid reservoir (2, 3, 4) mounted removable relative to the device, and, for each reservoir, electrically powered elements for diffusing (11, 12, 13, 18, 19) into the atmosphere the fluid(s) contained in the reservoir. The device comprises elements, for each reservoir, for storing (28, 29, 30) data concerning the reservoir and/or the fluid(s) it contains, rigidly fixed on the reservoir, and elements for controlling (1) the diffusing elements (18, 19) designed to verify, on the basis of data contained in the storage elements (28, 29, 30) of each reservoir (2, 3, 4) the fulfilment of predetermined conditions corresponding to a possibility of re-introducing fluid into the reservoir, and to inhibit the diffusing elements (11, 12, 13) associated with the reservoir if at least on of those conditions is fulfilled.

The invention relates to a device for diffusing into the atmosphere a fluid, more particularly a liquid, contained in a removable reservoir, such as a diffuser of scent, deodorant or bactericide for hospitals, railway stations, airports, large floor areas (in particular for marketing purposes), etc., a sprayer for crops, livestock, etc.

Various types of diffusion devices are known today: aerosols; plug-in devices (electrical devices including a mains connection plug, a reservoir and a heating resistor able to vaporise a liquid carried by a wick dipped into the reservoir) and other lamps using wicks; ceramics, wood or leaves impregnated with perfume; diffusers using natural convection; diffusers using forced convection by means of a manual pump and diffusers using forced convection by means of a motor-driven pump (or compressor, for air or liquid). The invention relates to a device comprising electrically-powered diffusion means, such as the plug-in devices and the motor driven diffusers, and comprising a removable reservoir containing the fluid to be diffused.

Such known diffusion devices comprise either motor-driven diffusion means able to atomise (spray, nebulise, micronise, etc.) or to vaporise a liquid, or to diffuse a gas into the atmosphere, or heating means (electric resistor) able to vaporise a liquid. Some sophisticated devices (see, for example, FR 2 776 947) have in addition electronic means for determining the quantity of fluid remaining in the reservoir (in this example an electrical gauge) and/or electronic means for controlling motor-driven diffusion means (software for tracking emissions of atomised liquid). These latter devices control, for example, means for regulating the quantity of liquid diffused (by regulating the electric power supplied to a pump or a compressor feeding a gaseous flow to a venturi or supplying a liquid flow to a spray nozzle, for example, in the case of motor-driven diffusion means, or by regulating the electric power supplied to a resistor in order to regulate the temperature of a liquid in the case of means for diffusion by heating), depending on requirements defined by a user. Said means for controlling diffusion means may also include a timer enabling diffusion to be limited to certain times recorded in advance. Said control means may also be programmed to prevent actuation of the pump under certain conditions.

Thus, U.S. Pat. No. 5,825,975 describes multifunction apparatus for spraying and fumigating a fluid substance, comprising a removable reservoir equipped with an information storage medium holding at least binary information indicating whether the substance contained in the reservoir may be vaporised with the heater element of the device, the device also including a microprocessor programmed to prevent actuation of the pump of the device unless reading of the binary information indicates that the substance may be vaporised with the heater element and unless the presence of said heater element is also detected facing the outlet nozzle of the pump. The reservoir may also include coded information relating to the contents of the reservoir, such as the limit date for use of the product contained, which may be used by the microprocessor to prevent operation of the pump.

Moreover, the fluids used must meet standards relating to their toxicology and must be approved to be diffused in air-conditioning conduits, public places, etc. The use of a non-certified product may be hazardous if the product proves to be harmful to humans, causing, for example, respiratory or cutaneous disorders or even serious or fatal intoxication through inhalation.

These known devices leave the possibility of replenishing the removable reservoir when it is empty to the user. This gives rise to a risk that the user might consciously or unconsciously fill the reservoir with a non-certified fluid. This operation is sometimes made difficult in certain devices by the structure of the reservoir itself (narrowness of the fluid outlet aperture and absence of an inlet aperture for supplying said reservoir with fluid, for example), or of a part of the diffusion means carried by the reservoir (internal fluid outlet pipe the arrangement of which makes filling difficult because of hydraulic resistance opposed to its free end, as described in EP-0 517 388). The risk of error is not negligible and can have grave consequences. Moreover, only a specific, complex and costly mechanical structure could allow filling of the reservoir by the user to be prevented, and would not guarantee absolute safety.

It is therefore the object of the invention, in its different variants, to propose a diffusion device having a secured removable reservoir which mitigates the above-mentioned disadvantages. In particular, it is an object of the invention to propose a reloadable device which prevents any introduction of fluid into the reservoir by a user in order definitively to avert the risk of filling with a toxic product.

A further object of the invention is to allow checking of the validity of a new reservoir and of the fluid it contains during its installation and utilisation. The invention aims in particular to provide the possibility of monitoring the type of fluid which is ready to be diffused, its limit date (checked during installation of the reservoir and also during operation) and to check the compatibility of said fluid with the motor-driven diffusion means used in order to avoid any risk of deterioration of said motor-driven diffusion means (due to unsuitable viscosity of the fluid or to an excessive corrosive property, for example).

A further object of the invention is to propose a diffusion device by virtue of which the commercialisation and use of reservoirs can be entirely controlled by the manufacturer of the device by reserving exclusive use of reservoirs sold by a manufacturer to the diffusion device produced by same manufacturer, for the safety reasons cited above and also for industrial and commercial reasons.

To this end, the invention relates to a device for diffusing at least one fluid into the atmosphere, comprising at least one reservoir containing at least one fluid and mounted removably with respect to the device and, for each reservoir, means for diffusing into the atmosphere the fluid(s) contained in the reservoir, which means are supplied with electric current, the device being characterised in that it comprises:

for each reservoir, storage means for information relating to the reservoir and/or to the fluid(s) it contains, rigidly fixed to the reservoir;

means for controlling the diffusion means, which control means are adapted to verify on the basis of information contained in the storage means of each reservoir the fulfilment of predefined conditions corresponding to a possibility of reintroducing fluid into the reservoir, and are adapted to inhibit the diffusion means associated with said reservoir if at least one of these conditions is fulfilled (if such a condition is fulfilled it is impossible to guarantee that the fluid reintroduced is suitable for diffusion).

It should be noted that the expression “the control means are adapted to inhibit the diffusion means associated with a reservoir” means that said control means are adapted to inhibit at least a part of the means for diffusing fluid contained in the reservoir in such a way as to prevent diffusion of said fluid. In particular, if the device includes a plurality of reservoirs which share at least a part of their means of diffusion, only the part of said diffusion means belonging to the reservoir is inhibited, should the need arise, by the control means.

Advantageously, according to the invention the control means are also adapted to inhibit the diffusion means associated with a reservoir if at least one of the predefined conditions for the validity of the fluid contained in the reservoir, relating to the characteristics of said fluid, is not fulfilled (fluid not certified, fluid out of date., viscosity of fluid unsuitable for the diffusion means associated with the reservoir, etc.).

To this end, according to the invention the information storage means of each reservoir advantageously include information, referred to as fluid identification information, relating to the characteristics of the fluid it contains, such as its type, its certification, its limit date, its viscosity, the maximum authorised delivery rate of the fluid diffused, the diffusion means compatible with the fluid, etc.

In one embodiment of the invention the information storage means of each reservoir contain information relating to the reservoir including, for example, at least one item of information, referred to as reservoir identification information, which enables the control means to identify the reservoir individually.

According to the invention the information storage means advantageously include at least one memory of the read-only type, for storing the reservoir identification information and/or the fluid identification information. This may be a memory of the ROM (Read Only Memory) type definitively programmed by its manufacturer, or preferably an OTP (One Time Programmable) memory supplied in the “virgin” state to the manufacturer of the present device and definitively programmed by the latter. This characteristic of the invention allows a maximum level of safety to be ensured with regard to the truth of the verifications carried out (relating to conditions expressing a risk of filling the reservoir with, and possibly using, an invalid fluid), the user being unable to modify the information relating to the reservoir or to the fluid contained in the read-only memory. As a variant, a memory of the EEPROM type (readable and writable) may also be used, said memory providing a level of safety which is satisfactory although inferior to that obtained with a read-only memory, because it can possibly be falsified by a user with knowledge of information technology and possessing the necessary equipment. According to the invention the above-mentioned information is advantageously encrypted for greater security. It should be noted that the memories used should be nonvolatile, in order to preserve said information when without voltage.

In a first embodiment of the invention, in which the information storage means of each reservoir include at least one memory of the writable type, the device includes means for detecting the installation of a reservoir in the device, and the control means are adapted to carry out the following operations during installation of the reservoir in the device:

to write into the storage means of the reservoir in a non-reversible manner information expressing the used state of said reservoir if this information is not present in the said storage means;

to inhibit the diffusion means associated with the reservoir being installed if the information expressing the used state of the reservoir is already present in the storage means.

In a second embodiment of the invention, in which the control means include means for recording information and the device includes means for detecting the installation of a reservoir, said control means are adapted to carry out the following operations during installation of a reservoir in the device:

to write the reservoir identification information into the recording means if said information is not present in said recording means;

to inhibit the diffusion means associated with the reservoir being installed if the reservoir identification information is already present in the recording means.

In the two preceding embodiments every new reservoir is therefore marked or recorded as being used by the control means when first installed. If such a reservoir is removed from the device to be filled and then reinstalled in the device, it is immediately recognised as being an already used reservoir by the control means, which automatically inhibit the associated diffusion means.

According to the invention the means for detecting the installation of a reservoir at a given location in the device advantageously include means for periodically triggering a reading by the control means of the information storage means of the reservoir which may be present at the location in order to detect the presence of a reservoir, recording means for recording in the control means information expressing the presence or absence of a reservoir (optionally accompanied by the identification information of the reservoir present), and means for comparing information recorded successively for said location. Thus, the control means are informed of the recent installation of a reservoir if the presence of a reservoir is detected at a given location when the information recorded following the previous checking of this location expresses the absence of a reservoir. In this specific case the control means are adapted to check the used or not-used state of the reservoir as explained above. It should be noted that the frequency of checks for the presence of a reservoir at a given location should be sufficiently high to enable a user to be prevented from replacing an empty reservoir by a reservoir which has been already used and filled by the user, between two checks.

Advantageously, the device according to the invention includes autonomous electric power supply means for the control means and for the means for detecting the installation of reservoirs, in order to permit at least partial continuous operation of said control and installation detection means. Thus, in case of interruption of the mains power supply to the device, the device is supplied by said autonomous supply means (batteries, rechargeable battery, etc.). The control means are then adapted to switch to a reduced operating mode with low energy consumption (standby mode) in which only the operations to check the presence of a reservoir at each location are periodically executed. In case of a mains power cut the device therefore continues to detect possible removal and installation of reservoirs in order, for example, to inhibit the diffusion means associated with a reservoir installed during the power cut and identified as being a reservoir already used, once the power supply is restored.

In a third embodiment of the invention the device includes, for each reservoir:

means for measuring the quantity of fluid contained in the reservoir; the value of the quantity of fluid contained in the reservoir determined by suitable measuring means is stored either in recording means of the control means, in association with the reservoir identification information, in order to enable said control means to recognise the fluid quantity value corresponding to a given reservoir, or in information storage means of the reservoir, if these means include at least one writable (and readable) memory;

means for comparing fluid quantity values stored successively. In this embodiment the control means are adapted to inhibit the diffusion means associated with a reservoir if the comparison means associated with said reservoir detect an increase in the quantity of fluid.

In cases in which the fluid for diffusion contained in at least one of the reservoirs is a liquid, the means for measuring the quantity of fluid in said reservoir include, for example, means for measuring the electrical resistance of the liquid and means for calculating the quantity of liquid as a function of the electrical resistance measured and characteristics of the liquid. Any other sensor for measuring the level and/or volume and/or mass of the fluid remaining in the reservoir is also in accordance with the invention.

It should be noted that the embodiment which provides for storage of the fluid quantity values (or of the information expressing the used state) of each reservoir in its information storage means is particularly suited to any installation which includes a plurality of diffusion devices. Indeed, if the information is carried by the reservoir, any increase in the quantity of fluid it contains (or any removal of the reservoir followed by reinstallation) is detectable on all the diffusion devices, including the case in which the reservoir is removed from a first device and re-installed on a second device. The embodiment which provides for the storage of fluid quantity values (or of the information expressing the used state) of each reservoir, in conjunction with the reservoir identification information, in the recording means of the control means, does not allow variations in the quantity of fluid in a reservoir to be checked if this reservoir originates from another device or is installed in a new device. However, in the case of an installation which includes only one diffusion device, this embodiment ensures a very satisfactory level of safety because it denies all users the possibility of modifying the fluid quantity values determined by measuring means in the memory of the reservoir. In this case the user who wishes to bypass the safety device of the invention is obliged to modify the fluid quantity value in the memory of the control means containing said value, which memory can readily be made difficult of access, either mechanically or by software means.

According to the invention the control means are advantageously adapted to inhibit the diffusion means associated with a reservoir if the fluid quantity value determined by the measuring means associated with said reservoir is at least substantially zero, that is, if the reservoir is empty, this capability being provided in particular for energy-saving reasons.

In a fourth embodiment of the invention the device includes, for each reservoir, means for calculating the quantity of fluid diffused, and the control means are adapted to inhibit the diffusion means associated with a reservoir if the quantity of fluid diffused, calculated by said calculating means, is at least substantially equal to the quantity of fluid initially present in the reservoir, the reservoir's information storage means including information indicating the quantity of fluid initially present in the reservoir. In cases in which the fluid to be diffused contained in at least one of the reservoirs is a liquid and in which the diffusion means associated with said reservoir include at least a pump or an air compressor and a venturi, or at least a pump or a liquid compressor and a spray nozzle, said calculating means are adapted to calculate the quantity of fluid diffused as a function in particular of the viscosity of the liquid and of the electric power supplied to said pump or said compressor (i.e. the flow rate of air at the intake of the venturi or the pressure applied at the intake of the spray nozzle), said power being controlled by the control means.

This embodiment is inexpensive and simple to realise and utilise. However, it offers a safety level inferior to that of the preceding embodiments. Indeed, it does not allow filling of a reservoir by a user to be detected in real time. On the other hand, it renders such filling useless, the control means stopping diffusion as soon as a quantity of fluid corresponding to the quantity of fluid initially present in the reservoir has been diffused. The quantity of fluid added is therefore not diffused and the user is dissuaded from refilling a reservoir.

The value of the quantity of fluid calculated by the calculating means of each reservoir is stored, periodically or continuously, in a writable memory in the information storage means of the reservoir, or in the recording means of the control means, in association with the reservoir identification information. As a variant, only a range of values which contains the calculated quantity of fluid is stored in the information storage means of the reservoir; for this purpose the control means periodically “destroy” “tokens” of reservoir utilisation, each of which corresponds to a certain quantity of fluid diffused. To do this the information storage means of each reservoir include a writable memory comprising a limited number of binary information units (i.e. bits, each bit representing a reservoir utilisation token) which show the same value when the reservoir is new, each information unit representing a fraction of the quantity of fluid initially present in the reservoir, and the control means are adapted to:

determine, if required (see description with reference to the Figures), as a function of the initial quantity of fluid and the number of information units, the fraction of the initial quantity of fluid represented by each information unit (the information storage means of the reservoir including information indicating said initial quantity of fluid);

change, in an irreversible and periodic manner, the value of an information unit (i.e. “destroy a token”), the period between successive changes of value of two information units corresponding to the diffusion of a quantity of fluid at least substantially equal to said fraction of the initial quantity of fluid, and being determined by the means for calculating the quantity of fluid diffused;

inhibit the diffusion means associated with the reservoir when the values of all the information units have been changed.

Each reservoir thus has a utilisation credit in the form of tokens which it progressively consumes as the fluid is diffused.

Advantageously, in an embodiment according to the invention in which the fluid to be diffused from at least one reservoir is a liquid, the diffusion means associated with said reservoir include a filter adapted to retain and return to the reservoir droplets which exceed a given size, in particular are greater than 10 μm, and preferably greater than 2 to 3 μm.

It should be noted that the diffusion means associated with a reservoir may be carried entirely by the device and coupled to the reservoir during installation of the latter. As a variant, at least a part of the diffusion means associated with a reservoir is mounted removably with respect to the device and is carried by the reservoir, and the control means include means for verifying compatibility between the diffusion means carried by the reservoir and the diffusion means carried by an element fixed to the device, the information storage means of the reservoir containing at least one item of information enabling the control means to identify the diffusion means carried by the reservoir and/or the diffusion means able to be associated with the reservoir.

Advantageously, the device according to the invention includes means controlled by the control means for regulating the power supplied to the pump or compressor (and consequently the pressure applied to the intake of the spray nozzle and/or the flow rate of air at the intake of the venturi) in order to adjust the rate of delivery of fluid diffused. The control means according to the invention advantageously include a counter (and preferably a real-time counter indicating date and time) and are adapted to control in time the regulating means in order, for example, to adjust the delivery rate of diffused fluid as a function of predefined time ranges. The variations in the power supplied to the pump (or compressor) may be continuous and progressive or discontinuous and abrupt. The device also optionally includes a timer to enable programming of periodical interruption of the operation of the diffusion means. The device according to the invention advantageously also includes sensors adapted to determine the number of persons present in a diffusion zone in order to adjust the delivery of fluid diffused accordingly.

Advantageously, the device according to the invention includes a human/machine interface such as a keyboard and/or a touch screen and/or a display device and/or remote control means for communication of data to a user and/or for programming by the user of functions of the control means. In particular, the human/machine interface allows transmission to the user of information relating to diffusion, such as the delivery rate of fluid diffused, the quantity of fluid remaining in the reservoir (in particular enabling a warning light or tone to be triggered if the reservoir is empty), the type of fluid and any other characteristic of the fluid, together with diverse information such as the date and time etc. The human/machine interface also allows the user to enter certain information and in particular to program controlled modes of diffusion into the counter and/or the timer, to select the reservoir or reservoirs to be used, etc.

The invention also relates to a diffusion device characterised in combination by all or some of the characteristics mentioned herein above and below.

Other objectives, characteristics and advantages of the invention will be apparent from a reading of the following description which refers to the appended drawings representing preferred embodiments of the invention which are given solely as non-limiting examples, and in which:

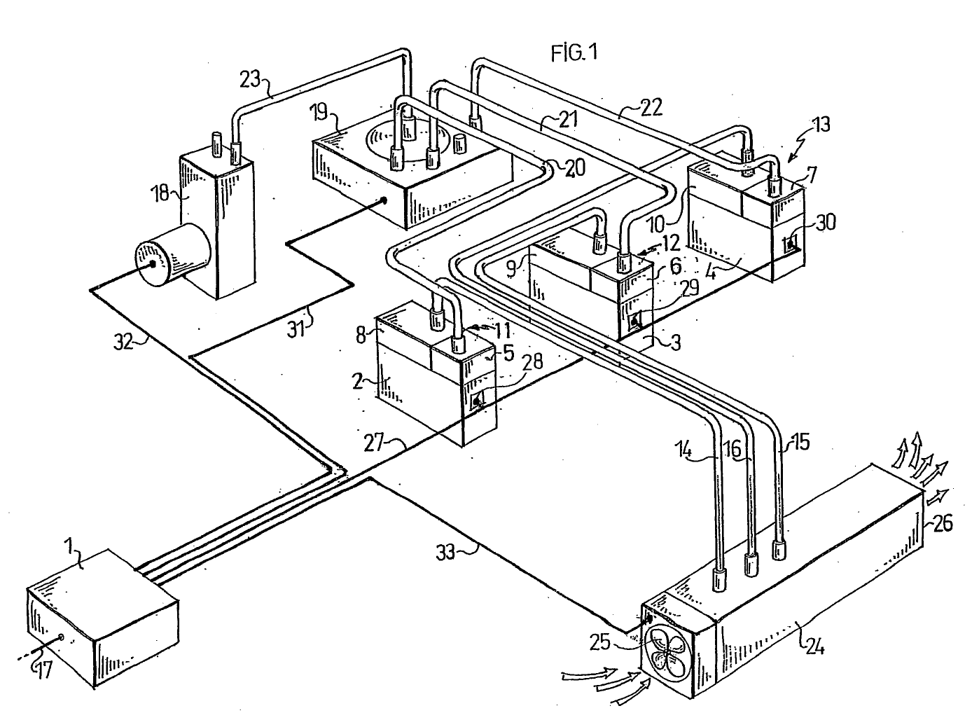

FIG. 1 is a schematic perspective view of an embodiment of the invention;

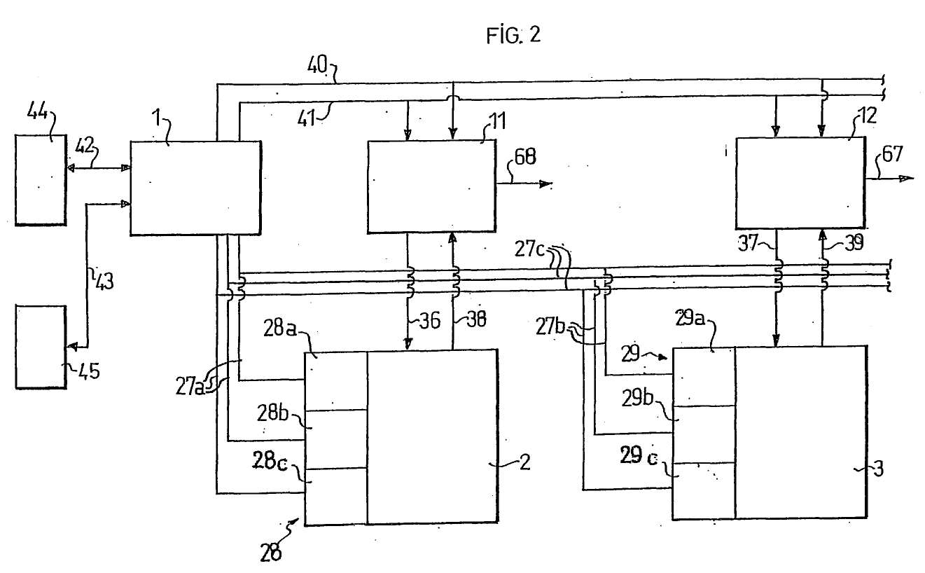

FIG. 2 is a functional diagram of an embodiment of the invention, and

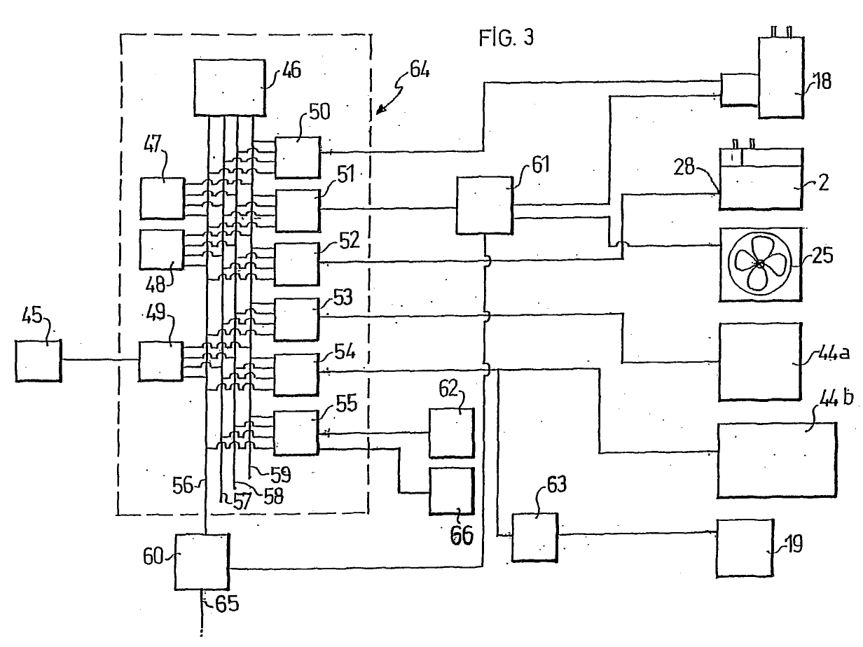

FIG. 3 is a block diagram of an embodiment of the control means.

The diffusion device illustrated in FIG. 1 comprises three reservoirs 2, 3 and 4 each rigidly fixed to a part 11, 12, 13 of the diffusion means, which part 11, 12, 13 is referred to as the atomising device. The diffusion means also comprise an air pump 18 upstream of the three reservoirs 2, 3, 4 and atomising devices 11, 12, 13. Each assembly {reservoir+associated atomising device} is fixed removably to the device at the end of an outlet pipe 14, 15, 16 transporting the mist of microdroplets created by the atomising device 11, 12, 13.

As an example, the atomising device 11, 12, 13 includes a venturi 5, 6, 7 supplied with an air flow generated by the air pump 18 and conveyed to the intake of the venturi 5, 6, 7 by an air feed pipe 20, 21, 22. It also includes a filter 8, 9, 10 for limiting diffusion to microdroplets the diameter of which does not exceed a given diameter of the order of a few micrometres. The filter 8, 9, 10 is so arranged that droplets of larger diameter are returned to the reservoir 2, 3, 4. The liquid for diffusion contained in the reservoir 2, 3, 4 is fed to the intake of the venturi 5, 6, 7 by any appropriate means (feed pipe). The atomising device may also include a nebulising device having successive stages, inclined baffles and successive venturis to break up the microdroplets obtained at the outlet of the main venturi and to enable a slight dispersion of sizes of microdroplets to be obtained, together with a flow accelerator to accelerate the flow of air and microdroplets at the outlet of the nebulising device. An atomising device of this kind is described in particular in French Patent Application FR 2 776 947.

Each reservoir 2, 3, 4 includes information storage means 28, 29, 30 for storing certain information and comprising, among other features, an electronic memory of read-only type such as an OTP memory parameterised and programmed definitively by the manufacturer of the device, or a ROM memory programmed by the manufacturer of same. This memory contains, for example, information, optionally encrypted, relating to the type of fluid contained by the reservoir, its certification, its limit date, its viscosity, the maximum authorised or recommended delivery of fluid diffused (some essential oils having very high odoriferous power may cause discomfort if diffused at a too-high delivery rate), the diffusion means which may be associated (type and maximum power of the pump, for example), etc.

The information storage means 28, 29, 30 also comprise an OTP-type memory formed by a very limited number of bits (information units) each representing a reservoir utilisation token. The OTP memory also includes a bit reserved for a token called the “out of service” token which is destroyed by the control means when the reservoir is considered to be empty (this is the last utilisation token of the reservoir) or when a condition for definitive inhibition of diffusion is fulfilled and registered by the control means (fluid not certified, limit date passed, etc.).

The device shown in FIG. 1 also includes means 1 for controlling the diffusion means. These control means 1 are linked to the memories 28, 29, 30 of each of the reservoirs by buses 27 for power supply and bidirectional communication to permit reading of information and destruction of the tokens contained in these memories 28, 29, 30 by said control means 1. The control means 1 are also connected to the air pump 18 by a power supply bus 32 with variable current and/or voltage in order to regulate the delivery rate of the air supplied by said air pump 18.

Since the embodiment illustrated in FIG. 1 comprises a plurality of reservoirs and associated atomising devices, a system of solenoid valves 19 is interposed between the air pump 18 and the different atomising devices 11, 12, 13 in order to allow distribution of the airflow generated by the pump between said atomising devices, and in particular to allow the user to select the reservoir to be used, or to allow the control means to automatically prevent diffusion of a fluid which does not meet the criteria of a nominal fluid. The solenoid valve system 19 is controlled by the control means 1 to which it is connected by a power supply and/or communication bus.

The control means 1 read the information stored in the memories 28, 29, 30 of each of the reservoirs in order to check, for example, whether the fluid contained in each reservoir is actually certified, if it is compatible with the diffusion means used and/or if the reservoir still has an available token (i.e. a token the value of which has not been changed) and, should this not be the case, to automatically prevent operation of the atomising device 11, 12, 13 concerned by stopping all supply of air to said device by means of the solenoid valve system 19 (valve closed).

The control means also comprise means for calculating the period between two destructions of utilisation tokens of the reservoir 2, 3, 4 and for controlling said destructions (transmission of an electrical signal addressed to a given token for the final destruction of the corresponding diode in the case of an OTP memory). Said period depends on the instantaneous consumption by the atomising means 11, 12, 13 of the reservoir (which depends on the instantaneous rate of delivery of air by the pump 18 to the intake of the venturi 4, 5, 6 and therefore on the electric power supplied to said pump by the control means 1), and on the viscosity of the fluid it contains (this information is read by the control means from the information storage means 28, 29, 30). The period between two destructions of tokens also depends on the quantity of diffused fluid represented by a utilisation token. This quantity is a datum defined by the manufacturer of the device and is identical for all its reservoirs (and in this case the number of tokens of a reservoir depends on the quantity of fluid initially present in the reservoir). As a variant, this quantity is calculated by the control means as a function of the initial quantity of fluid (value read from the information storage means 28, 29, 30 of the reservoir) and on the total number of tokens.

The control means 1 are also adapted to regulate the delivery rate of fluid diffused by acting on the air pump 18 upon a command by a user and/or in time (continuously or discontinuously) and/or as a function of information recorded in the memories 28, 29, 30 relating to the type of fluid present in the reservoir 2, 3, 4, its odoriferous power, its concentration and its possible effects on humans in cases in which these effects depend, for example, on the quantity of fluid inhaled, etc.

In this non-limiting example, the mist of microdroplets obtained at the outlets of the different reservoirs 2, 3, 4 is discharged into a ventilation conduit 24 by means of outlet pipes 14, 15, 16 before being discharged into the ambient air at an outlet aperture 26 of the ventilation conduit. This installation, starting from a single diffusion device, allows a fluid to be diffused into a plurality of zones interconnected by the ventilation conduit 24, said conduit having an outlet aperture 26 in each of the zones concerned. The ventilation conduit 24 is optionally equipped with a venturi (on the same axis as said conduit) downstream of the junction points between the conduit 24 and the outlet pipes 14, 15, 16, in which venturi the diffused microdroplets are sucked in and accelerated in such a way that the microdroplets released at the aperture 26 have diameters of the order of 1 micrometre and are thinly dispersed. Such a device, associated with heating means, allows said droplets to be vaporised if required.

Control of the mechanical ventilation system is effected in this example by the control means 1 of the diffusion device, said control means 1 being connected via a power supply bus 33 having variable current and/or voltage to a turbine 25 (or a fan) located in the ventilation conduit 24 upstream of the junction points between the conduit 24 and the outlet pipes 14, 15, 16 transporting the mist of microdroplets. The control means 1 can therefore act on the delivery rate of the air and therefore of the fluid diffused which circulates in this ventilation conduit 24 and is discharged into the ambient air at the outlet aperture 26. It should be noted in this regard that this air delivery rate ensures an additional dilution of the microdroplets diffused which should be taken into account when selecting the concentration of scent used and the regulation of the diffusion means.

FIG. 2 is a functional diagram showing the functional links between the different means utilised by the invention. The means utilised to realise these functional links (communication bus comprising a power supply bus, an address bus, a transfer bus for digital or analogue data and a control bus) are known by the person skilled in the art and will not be described in detail.

The embodiment illustrated in this Figure comprises a number n of removable reservoirs 2, 3, etc., each carrying a first memory (or a first space in a global memory) 28a, 29a of the read-only type and dedicated to information relating to the fluid (type, limit date, certification, viscosity, initial quantity), a second memory (or a second space in a global memory) 28b, 29b of the read-only type and dedicated to information relating to the reservoir 2, 3 (including, for example, a reservoir identification number), and a third, writable memory 28c, 29c of the EEPROM or OTP type comprising a limited number of bits representing utilisation tokens of the reservoir and the “out of service” token.

In addition, each reservoir 2, 3 is rigidly connected to an atomising device 11, 12 in which the mist of microdroplets discharged into the atmosphere (arrow 68, 67) is created. The connecting means between the reservoir and the atomising device are designed so that the liquid contained in the reservoir 2, 3 can be transported to the intake of the venturi (arrow 38, 39) and so that the microdroplets captured by the filter at the outlet of the venturi (or at the outlet of means for nebulising and/or accelerating the flow coupled to the venturi) are returned to the reservoir 2, 3 (arrow 36, 37).

The three above-mentioned memories 28a, 28b, 28c, 29a, 29b, 29c, etc. of the n reservoirs are connected to the control means 1 (links 27a, 27b, 27c) in such a way that the data contained in these memories can be read and utilised by said control means 1 and that said control means can transmit signals to the memories 28c, 29c. The control means 1 are also connected to the diffusion means (in practice to the pump 18 and to the solenoid valve system 19) in order to activate/deactivate same (command 40, acting on the solenoid valve system 19 and/or the pump 18) or to regulate same (command 41, acting on the pump 18).

Finally, the control means can be controlled by a user through the intermediary of a human/machine interface 44 located on the diffusion device (command 42) and/or by remote control means 45 (command 43).

The control means 1 prevent—or, conversely, authorise—operation of the diffusion means (command 40) of a reservoir 2, 3 if one of the following conditions is fulfilled—or, respectively, if none of the following conditions is fulfilled:

the reservoir is not recognised: it has no information storage means; it has information storage means which contain no data or contain data which are not readable or which do not correspond to fluid or reservoir data, etc.;

the “out of service” token has been destroyed (this is the first condition checked by the control means if the reservoir has been recognised; this is done to optimise the procedure for checking the conditions authorising diffusion);

the reservoir is considered empty (the “out of service” token has been destroyed as the last utilisation token of the reservoir);

the fluid contained in the reservoir is not certified (in this case the “out of service” token is immediately destroyed);

the limit date of the fluid has passed (“out of service” token destroyed);

the fluid is not compatible with the atomising device 11, 12 used (viscosity too high, for example), the last three conditions being verified by the control means 1 by accessing the information stored in the memory 28a, 29a.

The regulation 41 of the diffusion means (in practice regulation of the electric power supply to the air pump 18 to limit or increase the delivery of air to the intake of the venturi 5, 6) by the control means 1 intervenes:

on demand by the user, via the human/machine interface (keyboard and/or touch screen 44b, and/or remote control means 45), or according to predefined conditions entered by the user by means of the human/machine interface 44b, 45;

as a function of the type and concentration of the fluid to be diffused, according to the results of a calculation program executed by the control means 1 and making use of the information stored in the memory 28a, 29a;

as a function of given time ranges, the control means 1 including a timer, and/or according to preprogrammed modes successive in time, the control means 1 including a counter (or a real-time clock);

according to the number of persons present in the diffusion zone, the device including sensors (optical cells, for example, not shown in the appended Figures) for counting said persons, connected to the control means 1, etc.

FIG. 3 illustrates an embodiment of the control means 1. These means include a microcontroller 64 comprising:

a central processing unit 46 (CPU) for running the calculation, verification and comparison programs in order to monitor the reservoirs 2, 3 used and the fluids diffused, or control programs for activating/deactivating/regulating the diffusion means;

a memory 47 of the RAM (Random Access Memory) type for temporary storage operations occurring during execution of the programs cited above, this memory being preferably of the NVRAM (Non Volatile Random Access Memory) or the EEPROM type so as to be usable for possible recording of information relating to the reservoirs 2, 3 or their contents;

a read-only memory 48 of the ROM type for storing data (software, parameters, etc.) necessary for executing programs controlled by the CPU 46;

an internal clock 55 of the “time-keeper” type (real-time clock in the form of a preparametered date and time counter) powered by a battery 62, its frequency being governed by a quartz oscillation source 66;

a power modulator 51 (PWM chopper—Pulse Width Modulator, or modulator which varies frequency and/or amplitude), to regulate the diffusion means and/or a controlled mechanical ventilation system 24, said modulator 51 being connected to the air (or liquid) pump 18 of said diffusion means and/or to a fan 25 via a power stage 61, and optionally controlled by a timer and/or a counter and/or optical sensors, via the CPU 46;

an analogue-to-digital converter 50 for transmission to the CPU 46 of temperature values measured by any appropriate means at the pump 18 in order to detect possible malfunctions of the diffusion means such as a malfunction of the pump 18 or blockage of a venturi (such blockage causing over-pressure at the venturi intake and subsequent overheating of the motor of the pump 18). This converter, associated with means for measuring the pressure at the pump outlet, also allows the power supply to the pump motor to be controlled by said pressure measuring means in order to regulate the power supplied to the motor as a function of the electromotive force to which the motor is subjected as a result of said pressure. The control loop utilised allows the output of the pump 18 to be optimised;

a driver 53 of a liquid crystal display device (LCD driver), for example, for communication of data to the user;

a serial bus port 52 for data transfer between the CPU 46 and the memories 28a, 28b, 28c, 29a, 29b, 29c of the reservoir 2, 3 (reading of data contained by these memories, transmission of signals for destruction of tokens, etc.), each memory having an address allocated to it by the position of the reservoir in the device;

an input/output port 54 for data transfer between a keyboard 44b accessible by the user and the CPU 46, and also between the solenoid valve system 19 and said CPU 46 via a power stage 63;

an input/output port 49 for data transfer between the remote control means 45 and the CPU 46, the preceding elements being interconnected in known fashion by a bus called a backplane bus comprising a power supply bus 56 connected to the mains or to a battery 65 through the intermediary of a power supply stabiliser 60, and by a control bus 57, an address bus 58 and a data bus 59 for data transfer.

It is self-evident that the invention can be the subject of numerous variants in relation to the preferred embodiments described above and illustrated in the Figures.

In particular, in a more sophisticated variant, the device includes means, such as an electrical gauge, for measuring the quantity of fluid present in each reservoir. These means may be carried by the reservoir 2, 3, 4 or associated with the latter during its installation in the device. Measurement of the quantity of fluid may be continuous or periodic.

In this embodiment each reservoir includes among its data storage means 28, 29, 30 a readable and writable memory (of the EEPROM type) in which the quantity of fluid present in each reservoir, as determined by suitable measurement means, is stored at each moment or periodically. As a variant, the quantity of fluid measured by the measurement means is recorded in a readable and writable memory of the control means 1 with reference to the reservoir concerned. For this purpose, the memory 28b, 29b of the reservoir 2, 3 includes, for example, a pre-recorded reservoir identification number which is used as a reference when recording the value of the quantity of fluid in the memory provided for this purpose.

Each new measurement of the quantity of fluid in a reservoir is compared with the last measurement stored in said memory. If the new measurement is lower than the last measurement, it is recorded in place of said last measurement. In the opposite case, representing an increase in the quantity of fluid present in the reservoir, the control means 1 are adapted to actuate the closure of the solenoid valve (system 19) controlling the air supply to the atomising device 11, 12, 13 associated with said reservoir, and said last measurement is not recorded in the memory provided for this purpose. In the special case in which the last measurement is zero (reservoir empty) the control means 1 also actuate the closure of the solenoid valve and the measurement is recorded. This embodiment allows filling of the reservoir by the user to be detected in real time and allows the diffusion means associated with the reservoir to be inhibited immediately.

In the embodiment described with reference to the appended Figures, the atomising device associated with a reservoir is rigidly fixed to the latter and therefore is removable. In a variant in accordance with the invention said atomising device is fixed to the end of the outlet pipe 14, 15, 16 for the mist of microdroplets and only the reservoir is removable. In another embodiment in accordance with the invention only a part (the venturi, for example) of the atomising device is rigidly fixed to the reservoir and is therefore removable. In this case the memory 28b, 29b dedicated to information relating to the reservoir contains data defining the diffusion means carried by the removable reservoir and enabling the control means 1 to check the compatibility of said means with the diffusion means already present on the fixed part of the device according to the invention.

In another embodiment a plurality of removable reservoirs are connected to a single atomising device by means allowing access to the atomising device by the fluid contained in each of the reservoirs to be authorised or denied, according to predefined conditions and under the control of the control means.

It should be noted that the embodiment described with reference to the Figures has the advantage, as compared to the last three embodiments described above, of allowing the manufacturer and/or the distributors of the device to restrict maintenance operations on the devices sold and therefore the human and technical means to be utilised for this maintenance, a major part of the diffusion means (the atomising device) being changed each time the reservoir is changed.

It is self-evident, finally, that the conditions for authorising diffusion given above by way of example are non-limiting. Any another condition readily verifiable by the means utilised in the diffusion device is in accordance with the invention.

1. A device for diffusing at least one fluid into the atmosphere, comprising:
at least one reservoir (2, 3, 4) containing at least one fluid and mounted removably with respect to the device;
for each reservoir, means (11, 12, 13, 18, 19), supplied with electric power, for diffusing the fluid(s) contained in the reservoir into the atmosphere, and information storage means (28, 29, 30) fixed to the reservoir;
control means (1) for the diffusion means (18, 19),
the device being characterised in that:
the information storage means of each reservoir contain information relating to the reservoir and/or to the fluid(s) contained therein;
the control means (1) of the diffusion means (18, 19) are adapted to:
check, on the basis of the information contained in the information storage means (28, 29, 30) of each reservoir (2, 3, 4), the fulfilment of predefined conditions corresponding to a possibility of reintroducing fluid into the reservoir;
inhibit the diffusion means (11, 12, 13) associated with said reservoir if at least one of these conditions is fulfilled.

2. Device according to claim 1, characterised in that the information storage means (28b, 29b, 30) of each reservoir (2, 3, 4) contain at least one item of information, called the reservoir identification information, permitting the control means to identify the reservoir individually.

3. Device according either of claims 1 or 2, characterised in that the information storage means (28a, 29a, 30) of each reservoir (2, 3, 4) contain information, called fluid identification information, relating to characteristics of the fluid contained therein, such as its type, its certification, its limit date, its viscosity, the maximum delivery rate authorised for the fluid diffused and the diffusion means (11, 12, 13) compatible with the fluid.

4. Device according to either of claims 2 or 3, characterised in that the information storage means (28, 29, 30) include at least one memory (28a, 28b, 29a, 29b) of the read-only type for storing the reservoir identification information and/or fluid identification information.

5. Device according to claim 3, characterised in that the control means (1) are adapted to inhibit the diffusion means (11, 12, 13) associated with a reservoir (2, 3, 4) if at least one of the predefined validity conditions for the fluid contained in the reservoir (2, 3, 4) relating to the characteristics of said fluid is not fulfilled.

6. Device according to any one of claims 1 to 5, in which the information storage means (28, 29) of each reservoir include at least one memory of the writable type, characterised in that said device includes means for detecting the installation of a reservoir in the device, and in that the control means (1) are adapted to carry out the following operations when a reservoir (2, 3, 4) is being installed in the device:
write in an irreversible manner into the information storage means (28, 29) of the reservoir information expressing a used state of said reservoir (2, 3, 4) if this information is not present in said information storage means (28, 29);
inhibit the diffusion means (11, 12, 13) associated with a reservoir being installed if the information expressing the used state of the reservoir (2, 3, 4) is already present in the information storage means.

7. Device according to any one of claims 1 to 5 and according to claim 2, in which the control means (1) include means for registering information, characterised in that said device includes means for detecting the installation of a reservoir in the device, and in that said control means (1) are adapted to carry out the following operations when a reservoir (2, 3, 4) is being installed in the device:
write reservoir identification information into the recording means if said information is not present in said recording means;
inhibit the diffusion means (11, 12, 13) associated with the reservoir (2, 3, 4) being installed if the reservoir identification information is already present in the recording means.

8. Device according to either of claims 6 or 7, characterised in that the means for detecting the installation of a reservoir at a given location in the device include means for periodically triggering reading, by the control means, of the information storage means of the reservoir which may be present at the location for the purpose of detecting the presence of a reservoir, recording means for recording in the control means information expressing the presence or absence of a reservoir, and means for comparing information successively recorded for said location.

9. Device according to any one of claims 6 to 8, characterised in that it includes autonomous power supply means for the control means and the reservoir installation detection means in order to permit at least partial continuous operation of said control means and installation detection means.

10. Device according to any one of claims 1 to 9, characterised in that for each reservoir (2, 3) it includes means for measuring the quantity of fluid contained in the reservoir (2, 3).

11. Device according to claims 10 and 3, in which the fluid for diffusion contained in at least one of the reservoirs (2, 3, 4) is a liquid, characterised in that the means (34, 35) for measuring the quantity of fluid in said reservoir (2, 3) include means for measuring the electrical resistance of the liquid and means for calculating the quantity of liquid as a function of the electrical resistance measured and of characteristics of the liquid.

12. Device according to either of claims 10 or 11 and according to claim 3, in which the control means (1) include information recording means, characterised in that for each reservoir (2, 3) the value of the quantity of fluid contained in the reservoir determined by suitable measuring means is stored in the recording means in association with the reservoir identification information.

13. Device according to either of claims 10 or 11, in which the information storage means of each reservoir (2, 3) include a writable memory, characterised in that the value of the quantity of fluid contained in the reservoir determined by suitable measuring means is stored in the information storage means of the reservoir.

14. Device according to either of claims 12 or 13, characterised in that for each reservoir (2, 3) it includes means for comparing successive stored fluid quantity values, and in that the control means (1) are adapted to inhibit the diffusion means (11, 12) associated with a reservoir if the comparison means associated with said reservoir detect an increase in the quantity of fluid.

15. Device according to any one of claims 10 to 14, characterised in that the control means (1) are adapted to inhibit the diffusion means (11, 12) associated with a reservoir if the fluid quantity value determined by the measuring means associated with said reservoir is at least substantially zero.

16. Device according to any one of claims 1 to 15 and according to claim 3, characterised in that for each reservoir (2, 3) it includes means for calculating the quantity of fluid diffused, the control means (1) being adapted to inhibit the diffusion means associated with a reservoir if the quantity of fluid diffused, calculated by the calculating means associated with said reservoir, is at least substantially equal to the quantity of fluid initially present in the reservoir.

17. Device according to claim 16, in which the fluid for diffusion contained in at least one of the reservoirs (2, 3, 4) is a liquid, characterised in that the diffusion means (11, 12, 13) associated with said reservoir include at least a pump (18) or an air compressor and a venturi (5, 6, 7), or at least a pump or a liquid compressor and a spray nozzle, and in that the calculating means associated with said reservoir are adapted to calculate the quantity of fluid diffused as a function of the viscosity of the liquid and of the electrical power delivered to said pump or said compressor.

18. Device according to either of claims 16 or 17, characterised in that the information storage means of each reservoir (2, 3) include a writable memory (28c, 29c) containing a limited number of binary information units showing the same value when the reservoir is new, each information unit representing a fraction of the quantity of liquid initially present in the reservoir (2, 3), and in that the control means (1) are adapted to:
determine, if required, the fraction of the initial quantity of fluid represented by each information unit as a function of the initial quantity of fluid and the number of information units;
change in an irreversible and periodic manner the value of an information unit, the period between successive changes in value of two information units corresponding to the diffusion of a quantity of fluid at least substantially equal to said fraction of the initial quantity of fluid, said period being determined by the means for calculating the quantity of fluid diffused;
inhibit the diffusion means (11, 12) associated with the reservoir (2, 3) when the values of all of the information units have been changed.

19. Device according to any one of claims 1 to 18, in which the fluid for diffusion contained in at least one of the reservoirs is a liquid, characterised in that the diffusion means (11, 12, 13) associated with said reservoir include a filter (8, 9, 10) adapted to retain and return to the reservoir (2, 3, 4) droplets of a size larger than a given size, in particular larger than 3 μm.

20. Device according to any one of claims 1 to 19, characterised in that for each reservoir (2, 3, 4) at least a part of the diffusion means associated with the reservoir is mounted removably with respect to the device and is carried by the reservoir, and in that the control means (1) include means for checking the compatibility between the diffusion means carried by the reservoir and the diffusion means carried by a fixed element of the device, the information storage means (28, 29, 30) of the reservoir containing at least one item of information enabling the control means (1) to identify the diffusion means carried by the reservoir and/or the diffusion means which may be associated with the reservoir.

21. Device according to any one of claims 1 to 20, characterised in that it includes means (51, 61), controlled by the control means, for regulating the power supplied to the pump or compressor 18 in order to adjust the delivery rate of fluid diffused.

22. Device according to claim 21, characterised in that the control means (1) include a counter and/or a timer and/or means for determining the number of persons present in a diffusion zone in order to adjust, in time and/or as a function of said number of persons, the delivery rate of fluid diffused.

23. Device according to any one of claims 1 to 22, characterised in that it includes a human/machine interface (44a, 44b, 45), such as a keyboard and/or a touch screen and/or a display device and/or remote control means, for communicating data to a user and/or for the programming of functions of the control means (1) by the user.
